(19) United States
(12) Patent Application Publication
(10) Pub. No.: US 2026/0249368 A1
(43) Pub. Date: Aug. 27, 2026

(54) OPPOSED CUTTING MACHINE FOR END-OF-LIFE AUTOMOTIVE TIRES

(71) Applicant: SUZHOU CITY UNIVERSITY, Suzhou (CN)

(72) Inventors: Shiqiang ZHANG, Suzhou (CN); Kang XIE, Suzhou (CN); Zhitao LIANG, Suzhou (CN); Chao WANG, Suzhou (CN); Shuilin WANG, Suzhou (CN); Ming LEI, Suzhou (CN); Tao ZHUANG, Suzhou (CN)

(21) Appl. No.: 19/537,869

(22) Filed: Feb. 12, 2026

Related U.S. Application Data
(63) Continuation of application No. PCT/CN2025/088944, filed on Apr. 15, 2025.

(30) Foreign Application Priority Data
Feb. 24, 2025 (CN) 202510164747.9

(51) Int. Cl. B23D 45/00; B23D 45/10; B23D 47/04

(52) U.S. Cl. CPC B23D 45/003; B23D 45/10; B23D 47/047

(57) ABSTRACT

The invention provides an opposed cutting machine for end-of-life automotive tires, including a first opposed cutting machine body including a rotatably disposed first external expanding chunk having a plurality of first external expanding jaws, the first external expanding jaws are evenly distributed around a center of the first external expanding chunk and radially movable along the first external expanding chunk; a second opposed cutting machine body including a rotatably disposed second external expanding chunk having a plurality of second external expanding jaws, the second external expanding jaws are evenly distributed around a center of the second external expanding chunk and radially movable along the second external expanding chunk; and a saw blade feeding device for cutting tires. The first external expanding chunk is disposed right opposite the second external expanding chunk, and one of the first and second external expanding chunks is configured to be movable toward the other.

### FIELD OF THE INVENTION

The present invention relates to the field of tire cutting equipment technologies, and in particular, to an opposed cutting machine for end-of-life automotive tires.

### DESCRIPTION OF THE RELATED ART

With the rapid development of China's automotive industry, the number of end-of-life automotive tires has been continuously increasing, and the market for end-of-life automotive tires is expanding. The recycling and reuse of these tires have become an important part of the national strategic emerging industries. The recycling of end-of-life tires demonstrates significant social benefits in the development of circular economy. As a critical step in the recycling process, tire cutting and decomposition play a vital role in achieving the circular reuse of tire resources, holding broad market prospects.

Currently, in the process of cutting and decomposing automotive tires, conventional methods primarily rely on cutting equipment combined with manual assistance. This mode requires workers to flip tires and walk around them, resulting in low production efficiency and high labor intensity for workers. Furthermore, the working environment poses certain potential safety hazards. Any slight negligence may lead to accidental injury to operators. To effectively improve production efficiency, reduce labor intensity, and enhance the safety of the operating environment, there is an urgent need to introduce more efficient and safer solutions.

### SUMMARY OF THE INVENTION

For this, a technical problem to be resolved by the present invention is to overcome the problems in the related art that conventional tire cutting and decomposition manners have low operational efficiency of cutting and the operating environment poses potential safety hazards, and provide an opposed cutting machine for end-of-life automotive tires, thereby greatly improving the operational efficiency and safety of tire cutting.

To resolve the foregoing technical problems, the present invention provides an opposed cutting machine for end-of-life automotive tires, including:
a first opposed cutting machine body, including a first external expanding chunk provided with a plurality of first external expanding jaws, where the first external expanding chunk is rotatably disposed, and the plurality of first external expanding jaws are evenly distributed around a center of the first external expanding chunk and radially movable along the first external expanding chunk;
a second opposed cutting machine body, including a second external expanding chunk provided with a plurality of second external expanding jaws, where the second external expanding chunk is rotatably disposed, and the plurality of second external expanding jaws are evenly distributed around a center of the second external expanding chunk and radially movable along the second external expanding chunk; and
a saw blade feeding device, configured to cut tires, where
the first external expanding chunk is disposed right opposite the second external expanding chunk, and one of the first external expanding chunk and the second external expanding chunk is configured to be movable toward the other.

In an embodiment of the present invention, the opposed cutting machine further includes a tire lifting frame provided with a first driver, a pallet, and a plurality of cylindrical tubes, where the plurality of cylindrical tubes extend along a horizontal direction, the plurality of cylindrical tubes are arranged in an arc on the pallet or are linearly arranged on the pallet, the first driver drives the pallet to lift and lower, and when the first external expanding chunk and the second external expanding chunk are disposed right opposite in the horizontal direction, the tire lifting frame is disposed below a gap between the first external expanding chunk and the second external expanding chunk.

In an embodiment of the present invention, the first opposed cutting machine body further includes a first base and a second driver disposed on the first base, the first external expanding chunk is rotatably connected to the first base, and the second driver drives the first external expanding chunk to rotate; and the second opposed cutting machine body further includes a second base and a third driver disposed on the second base, the second external expanding chunk is rotatably connected to the second base, and the third driver drives the second external expanding chunk to rotate.

In an embodiment of the present invention, the second opposed cutting machine body or the first opposed cutting machine body further includes a guide post and a guide wheel assembly, the guide post extends along a movement direction of the second external expanding chunk or the first external expanding chunk, the guide wheel assembly includes a guide wheel bracket and a plurality of guide wheels rotatably connected to the guide wheel bracket, the plurality of guide wheels are rollingly connected to two sides of the guide post, and the second external expanding chunk and the third driver are disposed on the guide wheel bracket, or the first external expanding chunk and the second driver are disposed on the guide wheel bracket.

In an embodiment of the present invention, the second opposed cutting machine body or the first opposed cutting machine body further includes a fourth driver disposed on the second base, and the fourth driver drives the guide wheel bracket to move along the guide post.

In an embodiment of the present invention, the opposed cutting machine includes a plurality of guide posts and a plurality of guide wheel assemblies distributed in length directions of the guide posts, where axes of the plurality of guide posts do not coincide.

In an embodiment of the present invention, the guide wheel bracket is provided with a strip-shaped hole extending along a vertical direction and a screw hole passing through the strip-shaped hole, a rotating shaft of each of the guide wheels located below the guide post passes through the strip-shaped hole, a screw is threadedly connected to the guide wheel bracket through the screw hole, and threaded rods of the screws abut upward against two ends of the rotating shaft along the vertical direction.

In an embodiment of the present invention, the opposed cutting machine further includes a plurality of saw blade feeding devices symmetrically disposed on two sides of the tire, where one of the saw blade feeding devices is disposed on the guide wheel bracket.

In an embodiment of the present invention, a surface of each of the guide wheels is provided with an arc-shaped groove extending along a circumferential direction of the guide wheel, and the guide wheel is rollingly connected to the guide post through the arc-shaped groove.

In an embodiment of the present invention, a diameter of the arc-shaped groove is larger than a diameter of the guide post.

In an embodiment of the present invention, the guide wheel bracket includes two support members that are disposed right opposite and a support plate that connects the two support members, the second external expanding chunk and the third driver are both connected to the support plate, and the two ends of the rotating shaft of the guide wheel are rotatably connected to the two support members, respectively.

In an embodiment of the present invention, the support plate is located at top ends of the two support members, and the screw hole is located a bottom end of each of the two support members.

In an embodiment of the present invention, the second opposed cutting machine body further includes a machine body platform fixedly connected to the support plate, and the second external expanding chunk and the third driver are both connected to an upper side of the machine body platform.

In an embodiment of the present invention, the second opposed cutting machine body further includes a push frame fixedly connected to a lower side of the machine body platform, and the push frame is connected to an output end of the fourth driver.

In an embodiment of the present invention, the first external expanding chunk and the second external expanding chunk rotate synchronously or rotate separately.

Compared with the prior art, the foregoing technical solution of the present invention has the following advantages:

In the opposed cutting machine for end-of-life automotive tires of the present invention, the first opposed cutting machine body and the second opposed cutting machine body are symmetrically disposed, and the first opposed cutting machine body and the second opposed cutting machine body are used to perform cutting on two sides of a tire, so that the double-sided cutting of the tire is implemented, thereby improving cutting efficiency. The plurality of first external expanding jaws and second external expanding jaws extend into an inner ring of the tire and move toward an outer ring to expand and tighten the tire, so that the relative fixation between the tire and the first external expanding chunk and the relative fixation between the tire and the second external expanding chunk are implemented, the first external expanding chunk and the second external expanding chunk drive the tire to rotate to cooperate with saw blades to cut the tire along an annular path, and the double-sided cutting of the tire can be automatically completed, thereby reducing potential safety hazards in cutting work. The first external expanding chunk and the second external expanding chunk clamp and secure the tire from two sides, so that the stability of the tire in a cutting process is ensured, and an operator does not need to assist in limiting the tire, thereby further improving the safety for the operator.

### BRIEF DESCRIPTION OF THE DRAWINGS

To make the content of the present invention clearer and more comprehensible, the present invention is further described in detail below with respect to specific embodiments of the present invention and with reference to the accompanying drawings.

FIG. 1 is a schematic structural diagram of a front view of an opposed cutting machine for end-of-life automotive tires according to the present invention;

FIG. 2 is a schematic structural diagram of a top view of the opposed cutting machine for end-of-life automotive tires shown in FIG. 1;

FIG. 3 is a schematic structural diagram of a front view of a first opposed cutting machine body of the opposed cutting machine for end-of-life automotive tires shown in FIG. 1;

FIG. 4 is a schematic structural diagram of a top view of the first opposed cutting machine body shown in FIG. 3;

FIG. 5 is a schematic structural diagram of a front view of a second opposed cutting machine body shown in FIG. 1;

FIG. 6 is a schematic structural diagram of a top view of the second opposed cutting machine body shown in FIG. 5;

FIG. 7 is a schematic structural diagram of a left view of the second opposed cutting machine body shown in FIG. 6;

FIG. 8 is a schematic structural diagram of an enlarged view of a position A shown in FIG. 7;

FIG. 9 is a schematic structural diagram of a guide wheel bracket shown in FIG. 8;

FIG. 10 is a schematic structural diagram of a left view of the guide wheel bracket shown in FIG. 9;

FIG. 11 is a schematic structural diagram of a front view of a tire lifting frame shown in FIG. 1; and

FIG. 12 is a schematic structural diagram of a right view of the tire lifting frame shown in FIG. 11.

Reference numerals in the accompanying drawings of the specification: 1. tire lifting frame; 2. first opposed cutting machine body; 3. tire to be cut; 4. second opposed cutting machine body; 5. saw blade feeding device; 6. cylindrical tube; 7. support block; 8. pallet; 9. first driver; 10. first base; 11. intermediate support base; 12. first external expanding chunk shaft; 13. first bearing housing; 14. first external expanding jaw; 15. first external expanding chunk; 16. second driver; 17. first driving pulley; 18. first V-belt drive; 19. first driven pulley; 20. machine body platform; 21. guide wheel assembly; 22. guide post support member; 23. guide post; 24. second external expanding chunk; 25. second external expanding jaw; 26. second bearing housing; 27. second external expanding chunk shaft; 28. push frame; 29. machine body platform; 30. fourth driver; 31. driver bracket; 32. second base; 33. second driven pulley; 34. second V-belt drive; 35. second driving pulley; 36. third driver; 37. external expanding jaw guide groove; 38. rotating shaft of the first guide wheel; 39. strip-shaped hole; 40. first support member; 41. rotating shaft of the second guide wheel; 42. guide wheel bearing; 43. second guide wheel; 44. support plate; 45. second support member; 46. strip-shaped hole; 47. adjustment screw; 48. first guide wheel; 49. first screw hole; 50. second screw hole; 51. arc-shaped groove; and 52. saw blade feeding device.

### DETAILED DESCRIPTION OF THE PREFERRED EMBODIMENTS

The present invention is further described below with reference to the accompanying drawings and specific embodiments, to enable a person skilled in the art to better understand and implement the present invention. However, the embodiments are not used to limit the present invention.

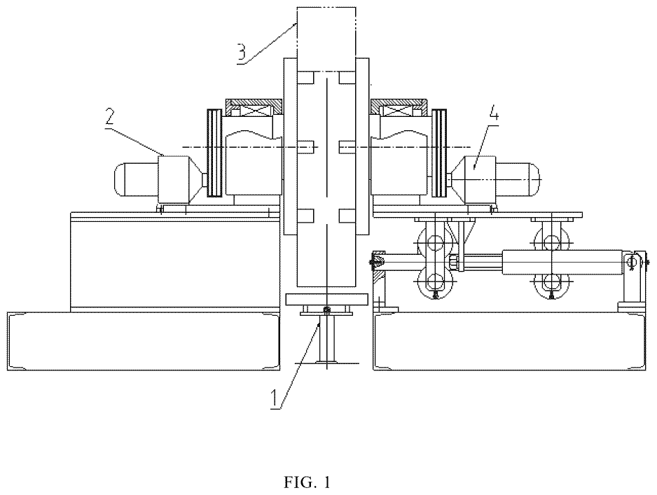

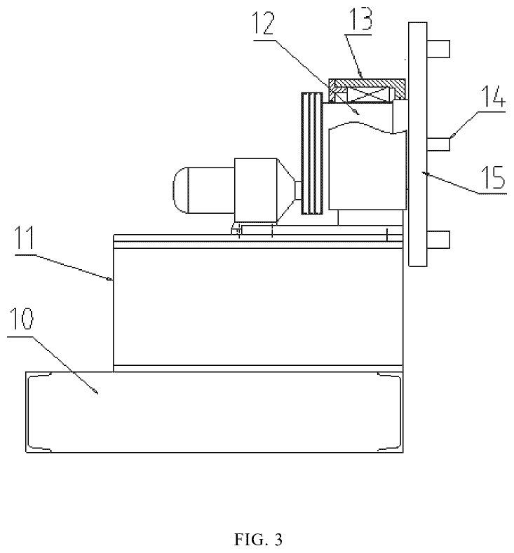

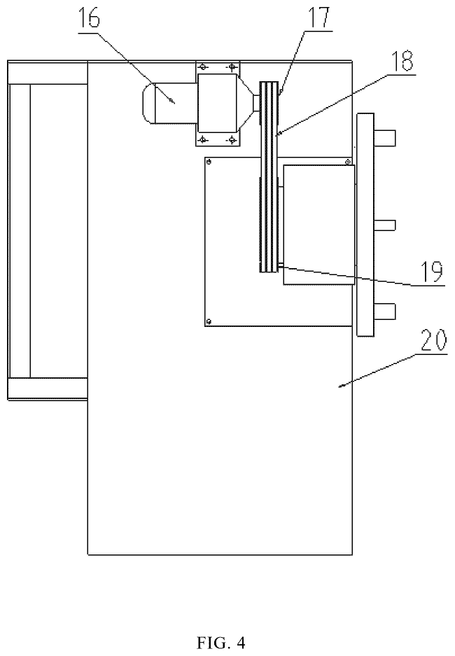

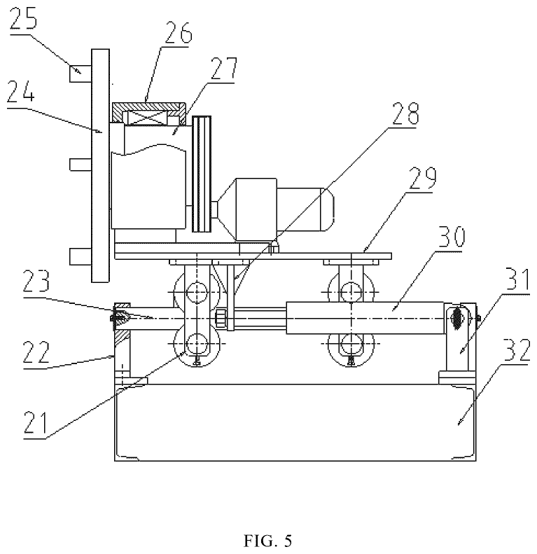

Referring to FIG. 1, FIG. 3, FIG. 4, and FIG. 5, in an embodiment of the present invention, the present invention discloses an opposed cutting machine for end-of-life automotive tires, configured to cut side surfaces of an end-of-life tire 3, and cutting positions are between an inner ring and an outer ring of the side surfaces of the tire 3. The opposed cutting machine includes:
a first opposed cutting machine body 2, including a first external expanding chunk 15 provided with a plurality of first external expanding jaws 14, where the first external expanding chunk 15 is configured to be rotatable, and the plurality of first external expanding jaws 14 are evenly distributed around a center of the first external expanding chunk 15 and radially movable along the first external expanding chunk 15; and the plurality of first external expanding jaws 14 are configured to extend into the inner ring of the tire 3 to be cut from a side, and when the plurality of first external expanding jaws 14 move outward along a radial direction of the first external expanding chunk 15, the tire 3 to be cut can be expanded and tightened, so that the tire 3 to be cut is fixed integrally with the first external expanding chunk 15, thereby implementing the synchronous rotation of the tire 3 to be cut and the first external expanding chunk 15;
a second opposed cutting machine body 4, including a second external expanding chunk 24 provided with a plurality of second external expanding jaws 25, where the second external expanding chunk 24 is configured to be rotatable, and the plurality of second external expanding jaws 25 are evenly distributed around a center of the second external expanding chunk 24 and radially movable along the second external expanding chunk 24; the plurality of second external expanding jaws 25 are configured to go deep into the inner ring of the tire 3 from the other side of the tire 3 opposite to the side provided with the first external expanding chunk 15, and when the plurality of second external expanding jaws 25 move outward along a radial direction of the second external expanding chunk 24, the tire 3 to be cut can be expanded and tightened, so that the tire 3 to be cut is fixed integrally with the second external expanding chunk 24, thereby implementing the synchronous rotation of the tire 3 to be cut and the second external expanding chunk 24; and the structures and operating principles of the second external expanding chunk 24 and the first external expanding chunk 15 are consistent, and details are not described again; and
a saw blade feeding device 5/52, configured to precisely control a feeding direction, angle, and speed of a saw blade, so that the saw blade automatically cuts the tire, thereby greatly reducing labor intensity.

Axial directions of the first external expanding chunk 15 and the second external expanding chunk 24 extend along a horizontal direction, and the first external expanding chunk 15 and the second external expanding chunk 24 are disposed right opposite. The saw blades may perform double-sided cutting on the tire 3 on a left side and a right side. One of the first external expanding chunk 15 and the second external expanding chunk 24 is configured to be movable toward and away from the other. When moving toward each other, the first external expanding chunk 15 and the second external expanding chunk 24 may jointly clamp the tire 3 to improve the stability of the tire 3, thereby facilitating cutting, and when moving away from each other, the two may release the tire 3.

Further, the first external expanding chunk 15 is disposed as a common jaw chunk. The jaw chunk includes four jaws, a chunk body, and a transmission mechanism, a drive mechanism, a connecting disc, and the like that are disposed inside the chunk body and that are configured to implement the synchronous movement and opening and closing of the four jaws. Specifically, four first external expanding jaws 14 are connected to the four jaws, respectively. The chunk body is further provided with four external expanding jaw guide grooves 37. The four external expanding jaw guide grooves 37 are evenly distributed and extend along a radial direction of the chunk body. The four first external expanding jaws 14 can precisely move along the four external expanding jaw guide grooves 37, respectively. After the four first external expanding jaws 14 go deep into the inner ring of the tire 3, the drive mechanism drives the four first external expanding jaws 14 to synchronously expand externally to automatically expand and tighten the tire 3. The second external expanding chunk 24 is also disposed as a common jaw chunk, and details are not described again.

Further, diameters of the first external expanding chunk 15 and the second external expanding chunk 24 are both smaller than an outer diameter of the tire. After the first external expanding chunk 15 and the second external expanding chunk 24 clamp the tire, the outer ring of the tire can be located outside the first external expanding chunk 15 and the second external expanding chunk 24, so that the saw blades are in contact with the cutting positions on the tire.

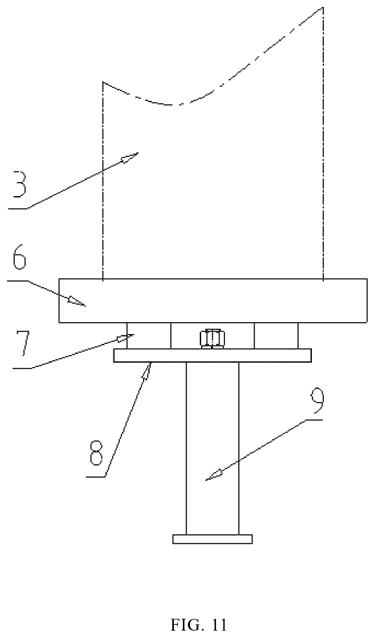

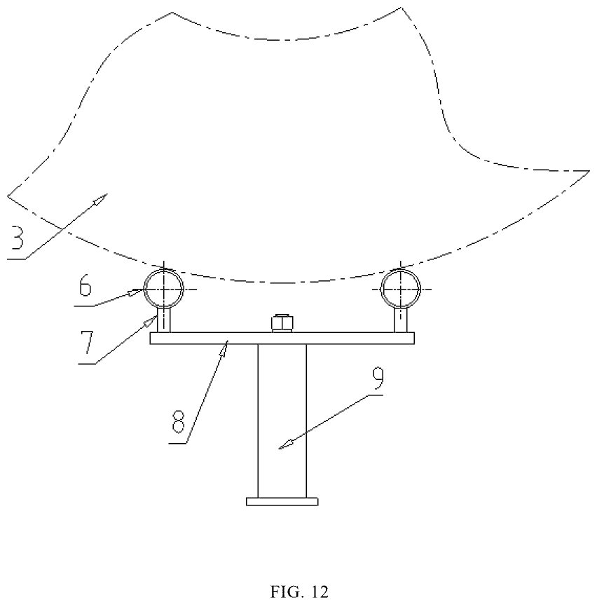

Referring to FIG. 1, FIG. 11, and FIG. 12, to automatically lift the tire 3 to be cut into a gap between the first external expanding chunk 15 and the second external expanding chunk 24 to enable the first external expanding jaws 14 and the second external expanding jaws 25 to extend into the inner ring of the tire 3, the opposed cutting machine further includes a tire lifting frame 1 provided with a first driver 9, a pallet 8, and a plurality of cylindrical tubes 6. The cylindrical tubes 6 are preferably steel tubes. The first driver 9 is preferably a hydraulic cylinder. The plurality of cylindrical tubes 6 extend along the horizontal direction and are linearly arranged on the pallet 8, and adjacent cylindrical tubes 6 are spaced apart. The tire 3 is placed on the cylindrical tubes 6. Smooth arcs of the cylindrical tubes 6 may facilitate the automatic adjustment of the tire 3 to centered placement. In other embodiments, the plurality of cylindrical tubes 6 are arranged in an arc on the pallet 8. The tire 3 is fully carried and supported using the plurality of cylindrical tubes 6 from the bottom and lateral portions, thereby preventing the tire 3 from rolling off during lifting and lowering. The first driver 9 is configured to drive the pallet 8 to lift and lower. When the first external expanding chunk 15 and the second external expanding chunk 24 are disposed right opposite in the horizontal direction, the tire lifting frame 1 is disposed below the gap between the first external expanding chunk 15 and the second external expanding chunk 24. The tire lifting frame 1 may lift the vertically placed tire 3 between the first external expanding chunk 15 and the second external expanding chunk 24.

Further, in this embodiment, the opposed cutting machine includes two horizontal cylindrical tubes 6 that are spaced apart, and the two cylindrical tubes 6 are fixed above the pallet 8 by a support block 7, so that the two adjacent cylindrical tubes 6 and the tire 3 form a stable triangle, thereby improving the stability of the tire 3.

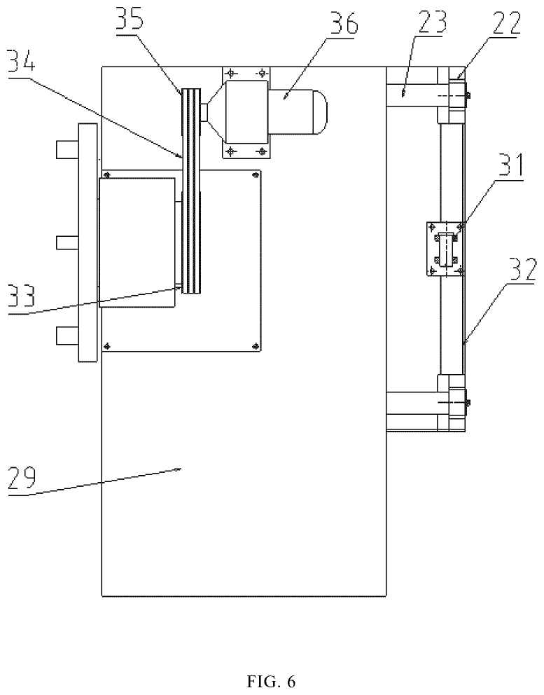

Referring to FIG. 4 and FIG. 6, further, the first opposed cutting machine body 2 further includes a first base 10, the first driver 9 disposed on the first base 10, and a first transmission mechanism. The first transmission mechanism includes a first bearing housing 13, a first bearing disposed on the first bearing housing 13, a first external expanding chunk shaft 12, a first driven pulley 19, a first driving pulley 17, a first V-belt drive 18, and the like. The first external expanding chunk 15 is rotatably connected to the first base 10. Specifically, the first external expanding chunk 15 is connected to the first bearing by the first external expanding chunk shaft 12. The first driver 9 is preferably a motor. The first driver 9 is configured to drive the first external expanding chunk 15 to rotate, thereby implementing the automatic rotation of the tire 3. Specifically, an output end of the first external expanding chunk 15 is connected to the first driving pulley 17, the first external expanding chunk shaft 12 is connected to the first driven pulley 19, and the first driven pulley 19 and the first driving pulley 17 are connected by the first V-belt drive 18 for power transmission.

Referring to FIG. 4 and FIG. 6, further, the second opposed cutting machine body 4 further includes a second base 32, a third driver 36 disposed on the second base 32, and a second transmission mechanism. The second transmission mechanism includes a second bearing housing 26, a second bearing disposed on the second bearing housing 26, a second external expanding chunk shaft 27, a second driven pulley 33, a second driving pulley 35, a second V-belt drive 34, and the like. The structures and principles of the second transmission mechanism and the first transmission mechanism are the same, and details are not described again. The second external expanding chunk 24 is rotatably connected to the second base 32 by the second bearing and the second external expanding chunk shaft 27. The third driver 36 is preferably a motor. The third driver 36 is configured to drive the second external expanding chunk 24 to rotate, thereby implementing the automatic rotation of the tire 3.

Further, the first opposed cutting machine body 2 further includes an intermediate support base 11 fixedly disposed on the first base 10. A second driver 16, the first driver 9, and the first transmission mechanism are all disposed on the intermediate support base 11.

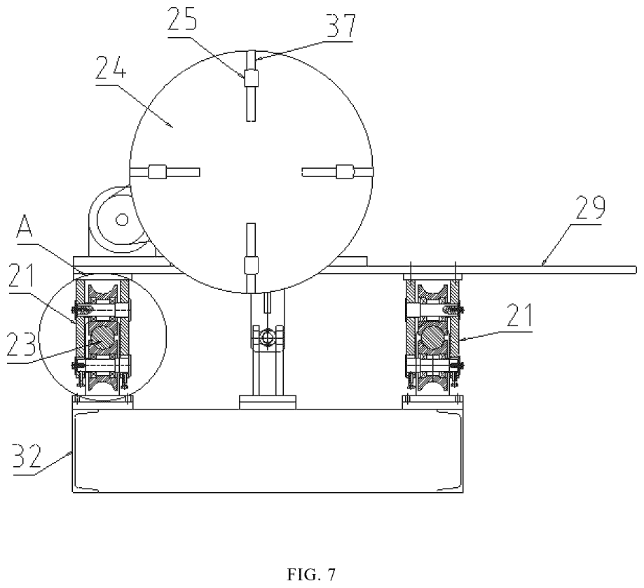

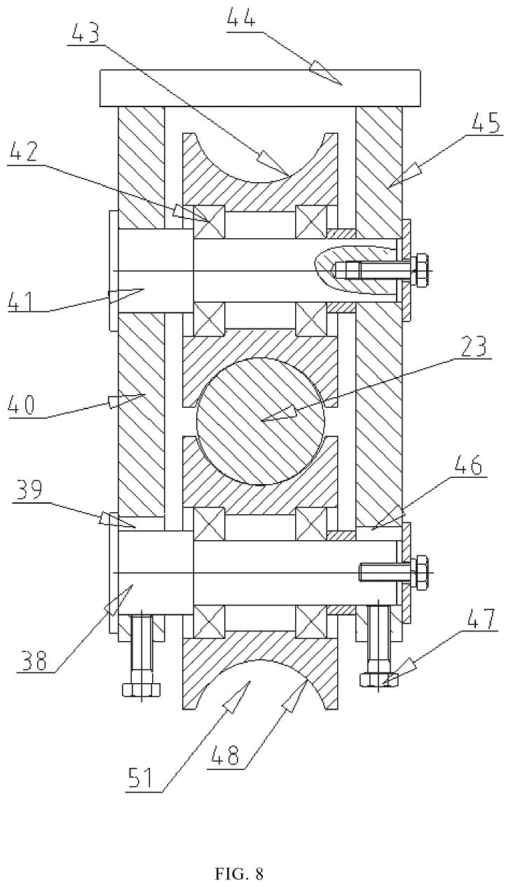

Referring to FIG. 1, FIG. 7, and FIG. 8, the second opposed cutting machine body 4 further includes a guide post 23 and a guide wheel assembly 21. A cross-section of the guide post 23 is circular, and the guide post 23 extends along a movement direction of the second external expanding chunk 24. The guide wheel assembly 21 includes a guide wheel bracket and a first guide wheel 48 and a second guide wheel 43 that are rotatably connected to the guide wheel bracket. When the guide post 23 extends along the horizontal direction, the second guide wheel 43 and the first guide wheel 48 are rollingly connected to an upper side and a lower side of the guide post 23, respectively. It may be understood that the guide post 23 passes through a gap between the second guide wheel 43 and the first guide wheel 48. Therefore, the guide wheel assembly 21 can move stably along the guide post 23. The second external expanding chunk 24 and the third driver 36 are both fixedly disposed on the guide wheel bracket. Therefore, the second external expanding chunk 24 can precisely move toward the first external expanding chunk 15 along the guide post 23.

Referring to FIG. 5, further, to tightly press the tire 3 using the second external expanding chunk 24, the second opposed cutting machine body 4 further includes a fourth driver 30 disposed on the second base 32. The fourth driver 30 is preferably a hydraulic cylinder. The fourth driver 30 drives the guide wheel bracket to move along the guide post 23. When the fourth driver 30 pushes the guide wheel bracket to the left, the second external expanding chunk 24 can tightly press a side surface of the tire 3. When the fourth driver 30 pushes the guide wheel bracket to the right, the second external expanding chunk 24 releases the tire 3.

Referring to FIG. 7, further, to stably support second external expanding chunk 24 and the third driver 36, the opposed cutting machine includes two guide posts 23 and four guide wheel assemblies 21 distributed along length directions of the guide posts 23. The two guide posts 23 are distributed on two sides of the second base 32, and axes of a plurality of guide posts do not coincide. The four guide wheel assemblies 21 are all distributed on the two sides of the second base 32. The four guide wheel assemblies 21 jointly support the second external expanding chunk 24 and the third driver 36.

Referring to FIG. 8, further, to adjust the height of the first guide wheel 48 to change a frictional force between the first guide wheel 48 and the guide post 23, the guide wheel bracket is provided with a strip-shaped hole 39 extending along a vertical direction and a screw hole 49 passing through the strip-shaped hole 39. A rotating shaft 38 of the first guide wheel 48 located below the guide post 23 passes through the strip-shaped hole 39. The strip-shaped hole 39 provides allowance for the vertical fine adjustment of the rotating shaft 38. A screw 47 is threadedly connected to the guide wheel bracket through a screw hole 50, and threaded rods of two screws abut upward against two ends of the rotating shaft 38 along the vertical direction. When the screws are rotated, the threaded rods may push the rotating shaft 38 to change the gap between the first guide wheel 48 and the guide post 23, thereby changing the frictional force between the two.

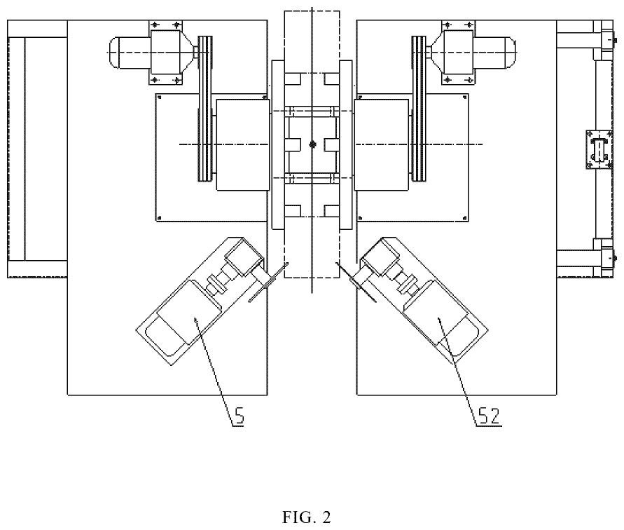

Referring to FIG. 2, the first opposed cutting machine body 2 further includes the saw blade feeding device 5, the second opposed cutting machine body 4 further includes the saw blade feeding device 52, and the two saw blade feeding devices 5/52 are symmetrically disposed on the first base 10 and the guide wheel bracket, respectively. The saw blades of the two saw blade feeding devices are disposed on two sides of the tire 3, so that double-sided cutting can be performed on the tire 3, thereby greatly improving the cutting efficiency of the tire 3, and reducing the labor intensity for an operator.

Referring to FIG. 8, further, to ensure that the first guide wheel and the second guide wheel can precisely move along the guide post 23, surfaces of the first guide wheel and the second guide wheel are provided with arc-shaped grooves 51 extending along circumferential directions of the first guide wheel and the second guide wheel. The guide wheels match the guide post 23 through the arc-shaped grooves 51, thereby achieving the objective of rollingly connecting the guide post 23.

Further, a diameter of the arc-shaped groove 51 is larger than a diameter of the guide post 23, thereby ensuring the effective contact between bottoms of the arc-shaped grooves 51 and an arc of the guide post 23.

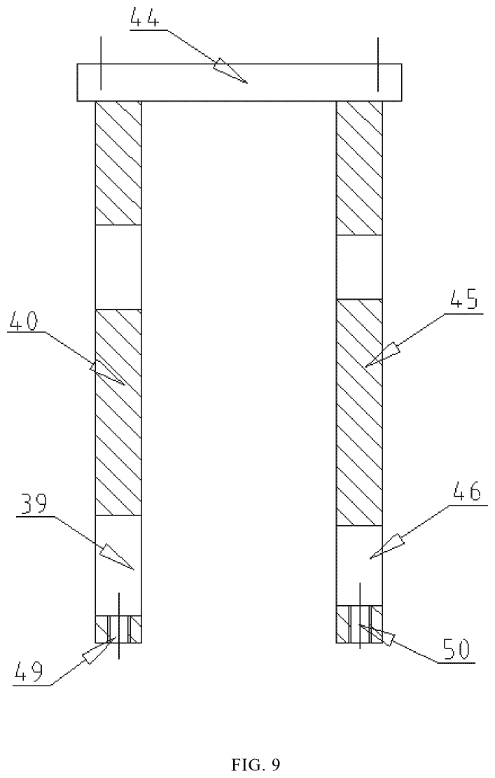

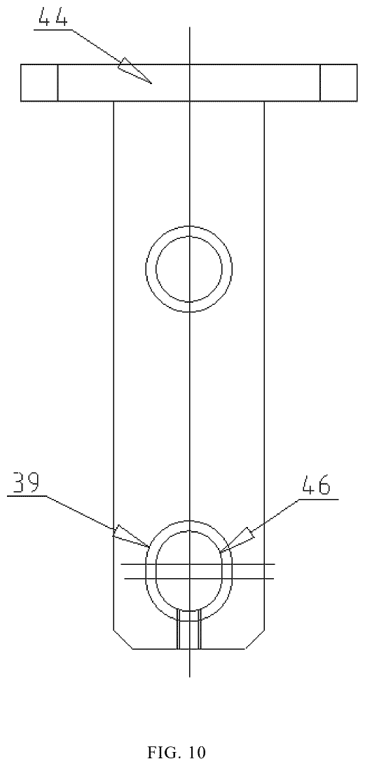

Referring to FIG. 9 and FIG. 10, further, the guide wheel bracket includes a first support member 40 and a second support member 45 that are disposed right opposite and a support plate 44 that fixedly connects the first support member 40 and the second support member 45. The second external expanding chunk 24 and the third driver 36 are both fixedly connected to the support plate 44. The first guide wheel 48 and the second guide wheel 43 are both disposed between the first support member 40 and the second support member 45. The two ends of the rotating shaft 38 of the first guide wheel 48 are rotatably connected to the first support member 40 and the second support member 45, respectively. Specifically, the first support member 40 and the second support member 45 are provided with the strip-shaped holes 39/46, respectively. The two ends of the rotating shaft 38 of the first guide wheel 48 pass through the strip-shaped holes 39/46, respectively. The first support member 40 and the second support member 45 may limit the first guide wheel 48 and the second guide wheel 43 to prevent the first guide wheel 48 and the second guide wheel 43 from deviating. Similarly, two ends of a rotating shaft 41 of the second guide wheel 43 are rotatably connected to the first support member 40 and the second support member 45, respectively.

Referring to FIG. 9, the support plate 44 is located at top ends of the first support member 40 and the second support member 45, and is configured to support the second external expanding chunk 24 and the third driver 36. The screw holes are located at bottom ends of the first support member 40 and the second support member 45, thereby facilitating fine adjustment of the screws by the operator.

Referring to FIG. 4 and FIG. 5, the second opposed cutting machine body 4 further includes a machine body platform 29, and a lower side of the machine body platform 29 is fixedly connected to support plates 44 of the four guide wheel assemblies 21. The second external expanding chunk 24, the third driver 36, and the saw blade feeding device are all connected to an upper side of the machine body platform 29. The first opposed cutting machine body 2 also includes a machine body platform 20 fixedly connected to the intermediate support base 11, and the first external expanding chunk 15, the first external expanding chunk 15, and the saw blade feeding device 52 are all connected to an upper side of the machine body platform 20.

Referring to FIG. 5, further, the second opposed cutting machine body 4 further includes a push frame 28 fixedly connected to the lower side of the machine body platform 29, the push frame 28 is connected to an output end of the fourth driver 30, and the fourth driver 30 pushes the push frame 28 to indirectly push the machine body platform 29 to move.

Referring to FIG. 5, further, the upper side of the machine body platform 29 is further provided with two guide post support members 22 that are configured to support two ends of the guide post 23, respectively.

Referring to FIG. 5, further, the second base 32 is further provided with a driver bracket 31 configured to support the fourth driver 30.

Further, the first external expanding chunk 15 and the second external expanding chunk 24 rotate synchronously or rotate separately.

Further, the opposed cutting machine further includes a synchronous starting device and a separate starting device. The synchronous starting device is configured to control the first external expanding chunk 15 and the third driver 36 to synchronously start, so that the first external expanding chunk 15 and the second external expanding chunk 24 are controlled to synchronously rotate. The separate starting device is configured to control the first external expanding chunk 15 and the third driver 36 to separately start, so that the first external expanding chunk 15 and the second external expanding chunk 24 are controlled to separately rotate.

In an embodiment of the present invention, the axial directions of the first external expanding chunk 15 and the second external expanding chunk 24 extend along the vertical direction, and the first external expanding chunk 15 and the second external expanding chunk 24 are disposed right opposite in the vertical direction, and the saw blades perform double-sided cutting on the tire 3 from an upper side and a lower side.

Further, when the first external expanding chunk 15 and the second external expanding chunk 24 are disposed right opposite vertically, the tire lifting frame 1 is disposed right opposite to the gap between the first external expanding chunk 15 and the second external expanding chunk 24, the tire lifting frame 1 may horizontally move the horizontally placed tire 3 to the gap between the first external expanding chunk 15 and the second external expanding chunk 24.

In an embodiment of the present invention, the first opposed cutting machine body 2 further includes a guide post 23 and a guide wheel assembly 21. The guide post 23 extends along a movement direction of the first external expanding chunk 15. The guide wheel assembly 21 includes the guide wheel bracket and the first guide wheel 48 and the second guide wheel 43 that are rotatably connected to the guide wheel bracket. The first guide wheel 48 and the second guide wheel 43 are respectively rollingly connected to two sides of the guide post 23. The first external expanding chunk 15 and the second driver 16 are disposed on the guide wheel bracket. Therefore, the first external expanding chunk 15 can precisely move toward the second external expanding chunk 24 along the guide post 23.

In an embodiment of the present invention, to tightly press the tire 3 using the first external expanding chunk 15, the first opposed cutting machine body 2 further includes a fourth driver 30 disposed on the first base 10. The fourth driver 30 is preferably a hydraulic cylinder. The fourth driver 30 drives the guide wheel bracket to move along the guide post 23. When the fourth driver 30 pushes the guide wheel bracket to the right, the first external expanding chunk 15 can tightly press a side surface of the tire 3, and when the fourth driver 30 pushes the guide wheel bracket to the left, the first external expanding chunk 15 releases the tire 3.

The operating principles of the opposed cutting machine for end-of-life automotive tires of the present invention are as follows:

The operator first vertically places the tire 3 to be cut on two cylindrical tubes 6 of the tire lifting frame 1. After the tire 3 to be cut is centered, the first driver 9 lifts the tire 3 to be cut until a center of the tire 3 to be cut is aligned with a center of the first external expanding chunk 15. The operator places the tire 3 to be cut against the first external expanding chunk 15, so that the four first external expanding jaws 14 extend into the inner ring of the tire 3 to be cut. Next, the four first external expanding jaws 14 move toward the outer ring of the tire 3. After the tire 3 is expanded and tightened, the tire lifting frame 1 is lowered. Subsequently, the third driver 36 pushes the push frame 28 to move to drive the machine body platform 29 to move to the left. The second external expanding chunk 24 stops pushing when coming into contact with a side surface of the tire 3 to be cut. In this case, the four second external expanding jaws 25 have already extended into the inner ring of the tire 3 to be cut. Next, the four second external expanding jaws 25 move toward the outer ring of the tire 3, and the tire 3 is expanded and tightened. Next, the third driver 36 continues to move to the left to push the machine body platform 29 until the second external expanding chunk 24 tightly presses the tire 3. Next, the second driver 16 and the third driver 36 drive the first external expanding chunk 15 and the second external expanding chunk 24 respectively to rotate simultaneously to drive the tire 3 to rotate. Finally, the two saw blade feeding devices 5/52 extend the saw blades. The two saw blades start to rotate and simultaneously cut the tire 3 from the two sides of the tire 3.

Obviously, the foregoing embodiments are merely examples for clear description, rather than a limitation to implementations. For a person of ordinary skill in the art, other changes or variations in different forms may also be made based on the foregoing description. All implementations cannot and do not need to be exhaustively listed herein. Obvious changes or variations that are derived there from still fall within the protection scope of the invention of the present invention.

What is claimed is:

1. An opposed cutting machine for end-of-life automotive tires, comprising:
a first opposed cutting machine body, comprising a first external expanding chunk provided with a plurality of first external expanding jaws, wherein the first external expanding chunk is rotatably disposed, and the plurality of first external expanding jaws are evenly distributed around a center of the first external expanding chunk and radially movable along the first external expanding chunk;
a second opposed cutting machine body, comprising a second external expanding chunk provided with a plurality of second external expanding jaws, wherein the second external expanding chunk is rotatably disposed, and the plurality of second external expanding jaws are evenly distributed around a center of the second external expanding chunk and radially movable along the second external expanding chunk; and
a saw blade feeding device, configured to cut tires, wherein
the first external expanding chunk is disposed right opposite the second external expanding chunk, and one of the first external expanding chunk and the second external expanding chunk is configured to be movable toward the other.

2. The opposed cutting machine for end-of-life automotive tires according to claim 1, further comprising a tire lifting frame provided with a first driver, a pallet, and a plurality of cylindrical tubes, wherein the plurality of cylindrical tubes extend along a horizontal direction, the plurality of cylindrical tubes are arranged in an arc on the pallet or are linearly arranged on the pallet, the first driver drives the pallet to lift and lower, and when the first external expanding chunk and the second external expanding chunk are disposed right opposite in the horizontal direction, the tire lifting frame is disposed below a gap between the first external expanding chunk and the second external expanding chunk.

3. The opposed cutting machine for end-of-life automotive tires according to claim 1, wherein the first opposed cutting machine body further comprises a second driver, and the second driver drives the first external expanding chunk to rotate; and the second opposed cutting machine body further comprises a third driver, and the third driver drives the second external expanding chunk to rotate.

4. The opposed cutting machine for end-of-life automotive tires according to claim 1, wherein the second opposed cutting machine body or the first opposed cutting machine body comprises a guide post and a guide wheel assembly, the guide post extends along a movement direction of the second external expanding chunk or the first external expanding chunk, the guide wheel assembly comprises a guide wheel bracket and a plurality of guide wheels rotatably connected to the guide wheel bracket, the plurality of guide wheels are rollingly connected to two sides of the guide post, and the second external expanding chunk and the third driver are disposed on the guide wheel bracket, or the first external expanding chunk and the second driver are disposed on the guide wheel bracket.

5. The opposed cutting machine for end-of-life automotive tires according to claim 4, wherein the second opposed cutting machine body or the first opposed cutting machine body further comprises a fourth driver, and the fourth driver drives the guide wheel bracket to move along the guide post.

6. The opposed cutting machine for end-of-life automotive tires according to claim 4, comprising a plurality of guide posts and a plurality of guide wheel assemblies distributed in length directions of the guide posts, wherein axes of the plurality of guide posts do not coincide.

7. The opposed cutting machine for end-of-life automotive tires according to claim 4, wherein the guide wheel bracket is provided with a strip-shaped hole extending along a vertical direction and a screw hole passing through the strip-shaped hole, a rotating shaft of each of the guide wheels located below the guide post passes through the strip-shaped hole, a screw is threadedly connected to the guide wheel bracket through the screw hole, and threaded rods of the screws abut upward against two ends of the rotating shaft along the vertical direction.

8. The opposed cutting machine for end-of-life automotive tires according to claim 4, further comprising a plurality of saw blade feeding devices symmetrically disposed on two sides of the tire, wherein one of the saw blade feeding devices is disposed on the guide wheel bracket.

9. The opposed cutting machine for end-of-life automotive tires according to claim 4, wherein a surface of each of the guide wheels is provided with an arc-shaped groove extending along a circumferential direction of the guide wheel, and the guide wheel is rollingly connected to the guide post through the arc-shaped groove.

10. The opposed cutting machine for end-of-life automotive tires according to claim 9, wherein a diameter of the arc-shaped groove is larger than a diameter of the guide post.
